(19) United States
(12) Patent Application Publication
(10) Pub. No.: US 2005/0257640 A1
(43) Pub. Date: Nov. 24, 2005

(54) Fiber reinforced plastic bicycle riser bar

(76) Inventors: Brad Addink, Madison, WI (US); John Balmer, Sun Prairie, WI (US); Christopher Robert Carlson, Waterloo, WI (US)

Correspondence Address: DAVID C. BREZINA;BARNES & THORNBURG LLP, P.O. Box 2786, Chicago, IL, 60690-2786, US

(21) Appl. No.: 10/850,879

(22) Filed: May 21, 2004

(51) Int. Cl. B62K 21/12

(52) U.S. Cl. 74/551.1

(57) ABSTRACT

A fiber reinforced plastic bicycle handlebar of the riser bar configuration has circular exterior surfaces throughout its length, with elliptical interior section oriented relative to the expected loads and the sweep and rise of the bar for improved weight, strength, stiffness and comfort, using a plurality of laminations in lay-up of fiber reinforced epoxy preimpregnated layers with fiber orientation and lamination numbers providing extra material to tune the desired strength, stiffness and flex, while reducing weight to a minimum.

### BACKGROUND OF THE INVENTION

1. Field of the Invention

A fiber reinforced plastic bicycle handlebar of the riser bar configuration has circular exterior surfaces, with elliptical interior section oriented relative to the expected loads and the sweep and rise of the bar for improved weight, strength, stiffness and comfort, using a plurality of compacted fiber/epoxy laminations.

2. Description of Related Art

Prior art includes a number of different structures. One structure is “butted” metal tubing used in bicycle frames and handlebars which have thickened walls at high stress locations such as the center portion of a handlebar or the ends of the tubes which are brazed in a “diamond” frame. Handlebars have been fitted with exterior sleeves at the center portion to improve strength at this high stress area.

U.S. Pat. No. 5,503,773 includes at least one section having variable thickness in the walls at the section (as opposed to “butted” tubing). This patent also discloses a method of manufacturing a fiber-reinforced plastic bicycle handlebar by an injection molding process. The carbon fiber straight bar has a thickened wall in the center portion. There is an oval section orientation, with an oval exterior and a thickened wall with a circular interior, as shown in FIG. 3c.

U.S. Pat. No. 5,557,982 discloses a composite handlebar having variable diameter tubing varying between the center, intermediate and end portions. A straight carbon fiber bar has an enlarged center portion. A high efficiency lightweight bicycle handlebar using strong, stiff fibers and a structural resin is disclosed. Relatively low modulus fibers are used in the axial direction and relatively high modulus fibers longitudinally.

U.S. Pat. No. 5,269,196 is for an injection molded handlebar having varying thickness in a center section.

U.S. Pat. No. 5,638,870 for a fiber-reinforced plastic tube adds laminations for added thickness at selected portions of the walls.

Published application No. 2003-0094067, entitled “Composite Handlebar for Bicycles” shows a drop bar comprising a one-piece curved handlebar member composed of a composite material.

Composite tubes and composite bicycle frames are shown in U.S. Pat. No. 5,271,784, No. 6,340,509, and No. 6,458,306, however these appear to teach different molding or forming methods.

U.S. Pat. No. 5,638,870, teaches a fiber-reinforced plastic tube having added laminations for added thickness at selected portions of the walls of a fishing rod, but does not teach variable sections having different axial orientation.

### SUMMARY OF THE INVENTION

A fiber reinforce plastic “Riser Bar” primarily for high performance mountain bicycles has (1) a large diameter center portion for clamping to the stem; (2) an intermediate portion on each side, (3) grip portions; (4) a rise of 4° and sweep of 7°; (5) use of-optimum compaction low void molding (“OCLV”) generally like U.S. Pat. Nos. 6,270,104 and 5,624,519; (6) sections having walls of varying thickness and orientation to maximize weight, strength and stiffness properties, namely (a) a center with a circular outer surface but an elliptical interior; (b) the intermediate is elliptical both exterior and interior with a constant wall thickness and (c) at the ends combining the circular outer surface and elliptical inner surface with a thicker top and bottom wall.

### BRIEF DESCRIPTION OF THE DRAWINGS

FIG. 1 is a perspective view of the carbon reinforced plastic riser bar.

FIG. 2 is a top plan view of the carbon reinforced plastic riser bar.

FIG. 3 is a front elevational view of the carbon reinforced plastic riser bar.

FIG. 4 is a sectional view of the carbon reinforced plastic riser bar at line 4-4.

FIG. 5 is a sectional view of the carbon reinforced plastic riser bar at line 5-5.

FIG. 6 is a sectional view of the carbon reinforced plastic riser bar at line 6-6.

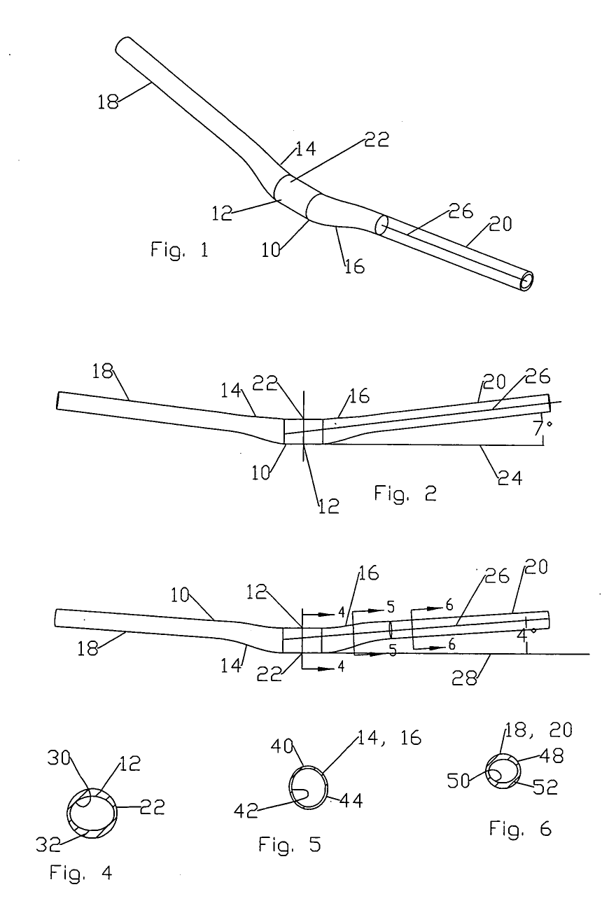

### DETAILED DESCRIPTION

A handlebar 10 has a large diameter center portion 12 for clamping to the stem of a bicycle. An intermediate portion 14, 16, extends from center portion 12 on each side. Intermediate portions 14, 16 end in respective grip portions 18, 20.

Center portion 12 is substantially cylindrical on its exterior surface 22. An imaginary line 24 extending parallel to surface 22 and an axis 26 of grips 18, 20 diverge from one another by a sweep angle of about 7 degrees, as shown in FIG. 2. 22. An imaginary line 28 extending parallel to surface 22 and axis 26 of grips 18, 20 diverge from one another by a rise angle of about 4 degrees as shown in FIG. 3.

Interior surface 30 is elliptical in section, defining, between itself and surface 22, a wall 32 having variable thickness, having a thicker upper and bottom limb, and thinner front and rear portions.

Generally conical surfaces 34, 36 of intermediate portions 14, 16 enable transition from center portion 12 to grips 18, 20. Exterior surface 40 is slightly elliptical, although very close to circular in section, being oriented with its long axis vertically. Interior surface 42 is substantially the same geometry, thus forming wall 44 of substantially uniform thickness. The two grips 18, 20 are symmetrical.

Outer surface 48 is circular in section and interior surface 50 is elliptical in section, defining, between them wall 52 having variable thickness, having a thicker upper and bottom limb, and thinner front and rear portions.

In addition to the ability to tune flex and stiffness, the use of circular sections for surfaces 22, 48 has the additional advantage of enabling the clamp mounting of standard handlebar stems, hand grips, brakes, shifters and the like.

The use of-optimum compaction low void (“OCLV”) bladder and female mold molding generally like U.S. Pat. Nos. 6,270,104 and 5,624,519 enables the deposition in the lay-up of additional laminations to define the thicker walls 32, 52, while maintaining strictly controlled exterior shapes. This then enables sections having walls of varying thickness and orientation to maximize weight, strength and stiffness properties, namely a center 12 with a circular outer surface but an elliptical interior the intermediate portions 14, 16 with slightly elliptical exterior and interior with a constant wall thickness and grips 18, 20 at the ends combining the circular outer surface and elliptical inner surface with a thicker top and bottom wall. The teachings of U.S. Pat. Nos. 6,270,104 and 5,624,519 and No. 5,503,773 are incorporated by reference as if fully set forth herein.

While a carbon reinforced plastic riser bar is the preferred embodiment, advantages would be present in other bar configurations. For example, varying elliptical interior sections in an all-circular exterior section “drop” bar could enable the use of high strength, light weight carbon fiber in a configuration that could be inserted in a traditional handlebar stem. In other configurations, improved aerodynamics in a “drop” bar, or improved ergonomics, could use the elliptical transition section, while retaining the greater stiffness in the center and grips, with the ease of use of standard fittings like a stem and brake levers.

Thus, while several embodiments have been shown and described with respect to the present invention, it should be understood that the present invention is not limited to these embodiments, but rather is susceptible to numerous changes and modifications as known to those skilled in the art. Therefore, we do not wish to be limited to the detail shown and described herein, and intend to cover all such changes and modifications as are encompassed by the scope of the appended claims.

1. A handlebar comprising:
a center portion having a first diameter;
said center portion being adapted for clamping to the stem of a bicycle;
an intermediate portion outboard of said center portion;
a grip portions outboard said intermediate portion;
said center portion being substantially cylindrical on its exterior surface;
said handlebar having a first imaginary line extending parallel to said center portion exterior surface;
said grip having a second diameter and an axis;
said first line and said axis diverge from one another by a sweep angle of about 7 degrees;
a second imaginary line extending parallel to surface so that said axis and said second line diverge from one another by a rise angle of about 4 degrees;
said center portion having a first interior surface elliptical in section, defining, between said first interior surface and said center portion exterior surface a first wall having variable thickness, having a thicker upper and bottom limb, and thinner front and rear portions;
a generally conical, but slightly elliptical in section, surface formed on said intermediate portion to enable transition from said center portion to said grip;
said generally conical, but slightly elliptical surface being oriented with its long axis vertically;
said transition portion having an interior surface of substantially the same geometry as said generally conical, but slightly elliptical surface, said transition portion surfaces forming a wall of substantially uniform thickness;
said grip being formed with a grip outer surface that is circular in section and a grip interior surface that is elliptical in section, defining, between the two grip surfaces, a wall having variable thickness, with the axis of said elliptical section aligned to define said wall with a thicker upper and bottom limb, and thinner front and rear portions.

2. A fiber reinforced plastic bicycle handlebar comprising:
center, intermediate and grip portions;
said center and grip portions having circular section exterior surfaces;
said center and grip portions having first and second elliptical interior sections, respectively;
an intermediate portion having a third elliptical interior section;
said elliptical sections being oriented relative to the expected loads and the sweep and rise of the bar for improved weight, strength, stiffness and comfort
said handlebar being formed using a plurality of compacted fiber/epoxy laminations.

3. The handlebar of claim 2 further comprising:
said first elliptical surface having a first axis;
said second elliptical surface having a second axis;
said third elliptical surface having a third axis;
said first axis and said second axis being oriented generally parallel to one another;
said third axis is oriented substantially perpendicular to said first and second axes.

4. The handlebar of claim 2 further comprising:
said center portion having a first diameter;
said center portion being adapted for clamping to the stem of a bicycle;
said intermediate portions being located outboard of said center portions;
said grip portions being located outboard said intermediate portion;
said center portion being substantially cylindrical on its exterior surface;
said center portion having a first interior surface elliptical in section, defining, between said first interior surface and said center portion exterior surface a first wall having variable thickness, having a thicker upper and bottom limb, and thinner front and rear portions.

5. The handlebar of claim 4 further comprising:
a generally conical surface formed on said intermediate portion, said generally conical surface being slightly elliptical in section, and said conical surface aligned to enable transition from said first diameter of said center portion to said second diameter of said grip portions.

6. The handlebar of claim 5, further comprising:
said generally conical, but slightly elliptical surface being oriented with its long axis vertically;
said transition portion having an interior surface of substantially the same geometry as said generally conical, but slightly elliptical surface, said transition portion surfaces forming a wall of substantially uniform thickness.

7. The handlebar of claim 6 further comprising:
said grip portions being formed with a grip outer surface that is circular in section and a grip interior surface that is elliptical in section, defining, between the two grip surfaces, a wall having variable thickness, with the axis of said elliptical section aligned to define said wall with a thicker upper and bottom limb, and thinner front and rear portions.

8. The handlebar of claim 7 further comprising:
said first elliptical surface having a first axis;
said second elliptical surface having a second axis;
said third elliptical surface having a third axis;
said first axis and said second axis being oriented generally parallel to one another;
said third axis is oriented substantially perpendicular to said first and second axes.

9. The handlebar of claim 8 further comprising:
said handlebar having a first imaginary line extending parallel to said center portion exterior surface;
said grip portions having a second diameter and an axis;
said first line and said axis diverge from one another by a sweep angle of about 7 degrees;
a second imaginary line extending parallel to said center portion surface so that said axis and said second line diverge from one another by a rise angle of about 4 degrees.

10. The handlebar of claim 8 further comprising:
said handlebar is formed of a lay-up of fiber reinforced plastic formed and arranged so that said varying wall thickness is formed by locating extra fiber laminations oriented where greater thickness is desired;
said laminations are compressed so that voids therebetween are substantially eliminated.

11. A handlebar comprising:
said handlebar is formed of a lay-up of fiber reinforced plastic formed and arranged so that said varying wall thickness is formed by locating extra fiber laminations oriented where greater thickness is desired;
said laminations are compressed so that voids therebetween are substantially eliminated;

12. The handlebar of claim 11 further comprising:
said handlebar having center, intermediate and grip portions;
said center and grip portions having circular section exterior surfaces;
said center and grip portions having first and second elliptical interior sections, respectively;
an intermediate portion having a third elliptical interior section;
said elliptical sections being oriented relative to the expected loads and the sweep and rise of the bar for improved weight, strength, stiffness and comfort
said handlebar being formed using a plurality of compacted fiber/epoxy laminations.

13. The handlebar of claim 12 further comprising:
said first elliptical surface having a first axis;
said second elliptical surface having a second axis;
said third elliptical surface having a third axis;
said first axis and said second axis being oriented generally parallel to one another;
said third axis is oriented substantially perpendicular to said first and second axes.

14. The handlebar of claim 13 further comprising:
said center portion having a first diameter;
said center portion being adapted for clamping to the stem of a bicycle;
said intermediate portions being located outboard of said center portions;
said grip portions being located outboard said intermediate portion;
said center portion being substantially cylindrical on its exterior surface;
said center portion having a first interior surface elliptical in section, defining, between said first interior surface and said center portion exterior surface a first wall having variable thickness, having a thicker upper and bottom limb, and thinner front and rear portions.

15. The handlebar of claim 14 further comprising:
a generally conical surface formed on said intermediate portion, said generally conical surface being slightly elliptical in section, and said conical surface aligned to enable transition from said first diameter of said center portion to said second diameter of said grip portions.

16. The handlebar of claim 15, further comprising:
said generally conical, but slightly elliptical surface being oriented with its long axis vertically;
said transition portion having an interior surface of substantially the same geometry as said generally conical, but slightly elliptical surface, said transition portion surfaces forming a wall of substantially uniform thickness.

17. The handlebar of claim 16 further comprising:
said grip portions being formed with a grip outer surface that is circular in section and a grip interior surface that is elliptical in section, defining, between the two grip surfaces, a wall having variable thickness, with the axis of said elliptical section aligned to define said wall with a thicker upper and bottom limb, and thinner front and rear portions.

18. The handlebar of claim 17 further comprising:
said first elliptical surface having a first axis;
said second elliptical surface having a second axis;
said third elliptical surface having a third axis;
said first axis and said second axis being oriented generally parallel to one another;
said third axis is oriented substantially perpendicular to said first and second axes.
